(19) United States
(12) Patent Application Publication
(10) Pub. No.: US 2025/0256993 A1
(43) Pub. Date: Aug. 14, 2025

(54) Electrodialysis with Perpendicular Water Flow and No Leaks

(71) Applicant: Ben Harrison Cantrell, Springfield, VA (US)

(72) Inventor: Ben Harrison Cantrell, Springfield, VA (US)

(21) Appl. No.: 19/169,242

(22) Filed: Apr. 3, 2025

(51) Int. Cl. C02F 1/469; C02F 1/46; C02F 103/08

(52) U.S. Cl. CPC C02F 1/4695; C02F 1/4604; C02F 2103/08; C02F 2201/4611; C02F 2201/46115

(57) ABSTRACT

This electrodialysis unit is similar to conventional electrodialysis units, but uses modified spacer structures that alter water flow patterns and prevents water leaks. In this design, both dilute and concentrate waters flow horizontally, but in perpendicular directions within their respective dilute and concentrate water spacers, while the electric ion current flows vertically. This arrangement provides a simple means of distributing the dilute and concentrate water across the breadth of their respective spacers and facilitates achieving a targeted level of leakage electric current and the associated power loss within the water distribution systems. Moreover, the improved dilute and concentrate spacer structures effectively eliminate the risk of internal water leaks. When integrated with a precipitation tank, this system enables Zero Liquid Discharge ZLD operation when wastewater from reverse osmosis desalination is treated with this electrodialysis unit.

### CROSS-REFERENCE TO RELATED APPLICATIONS

Patent application Ser. No. 18/128,382, Ben Harrison Cantrell, “Gated Electrodialysis with Zero Liquid Discharge,” Filed Mar. 30, 2023, Publication Number US-2024-0327257-A1, Publication Date Oct. 3, 2024

Patent application Ser. No. 18/679,573, Ben Harrison Cantrell, “Alternate Water Distributions in Electrodialysis Systems with ZLD Properties,” Filed May 31, 2024

### FEDERALLY SPONSORED RESEARCH OR DEVELOPMENT: Not applicable REFERENCE TO A “SEQUENCE LISTING”

Not Applicable

### NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND

### Field of the Invention

This invention is in the field of electrodialysis with applications to desalination.

### Description of the Related Art

Electrodialysis systems transfer ions from water with a lower ion concentration to water with a higher ion concentration, as described in Citation 1 of the INFORMATION DISCLOSURE STATEMENT BY APPLICANT (Form PTO/SB/08a (01-10)) under NON-PATENT LITERATURE DOCUMENTS. Briefly, these systems consist of a stack of alternating spacers that hold dilute and concentrate ionized water, respectively, between alternating anion and cation ion exchange membranes. When electrodes are placed in electrolysis water at each end of the stack and a voltage is applied, an electric field is generated, driving ions from the dilute water into the concentrate water. As a result, the dilute water loses ions, while the concentrate water gains ions.

The dilute and concentrated water distribution systems in an ordinary electrodialysis unit are generally constructed as follows. On one side of the electrodialysis unit, the dilute water is horizontally distributed from the bottom of one its ends to the bottoms of each dilute water spacer while passing through holes in the adjacent concentrate water spacers and ion exchange membranes. This dilute water then moves from the bottom to the top of each dilute water spacer. It is then retrieved from the top of each dilute water spacer and combined with the dilute water from other dilute water spacers while passing through holes in the tops of the adjacent concentrate water spacers and ion exchange membranes. Finally, it exits at the top of the top end piece. The concentrate water distribution system is like the dilute water distribution system, except that the feed/retrieval concentrate water to/from the interior of the concentrate water spacer resides on the opposite side of the electrodialysis unit, and the notations for dilute and concentrate water are reversed. The ions move horizontally. The dilute and concentrate water spacers are typically about one-sixteenth of an inch thick. Two key features of these dilute and concentrate water distribution arrangements are: (1) the flow of the dilute and concentrate waters in the central region of the relatively thin dilute and concentrate spacers is parallel in the upward direction and may not be well distributed across the breadth of the spacers without special considerations and (2) there is a potential for internal water leaks when the dilute water passes through the holes in the concentrate water spacers and ion exchange membranes and when the concentrate water passes through the holes in the dilute water spacers and ion exchange membranes. This last issue can be mitigated to a significant extent by maintaining equal water pressure in the dilute and concentrate water distribution systems.

Unlike ordinary electrodialysis systems, which typically have parallel vertical flows of dilute and concentrate water in the central regions of their respective dilute and concentrate water spacers, with ions flowing horizontally, this invention's electrodialysis system features both dilute and concentrate water flowing horizontally but in perpendicular directions relative to each other, while ions flow vertically, all within the central region of the spacers where ion flow occurs. This new arrangement of dilute and concentrate water flow provides a simple method for distributing the dilute and concentrate waters across the breadth of their respective spacers. Furthermore, this invention introduces dilute and concentrate water spacer designs and constructions that eliminate leaks in the dilute and concentrate water distribution systems. This is achieved by making the dilute and concentrate spacers thicker (around three-eighths of an inch) compared to ordinary dilute and concentrate water spacers, which are approximately one-sixteenth of an inch thick, and by adding structural enhancements to the water paths within the spacers. Additionally, a targeted electric leakage current and the associated power loss in the internal water distribution systems can be indirectly determined by the design dimensions within the spacers and the conductivities of the dilute and concentrate waters. Finally, an example is provided of how this electrodialysis unit could be used to process the wastewater from a reverse osmosis unit and how this arrangement could enable Zero Liquid Discharge (ZLD) operation.

### BRIEF SUMMARY OF THE INVENTION

This invention's electrodialysis system is constructed and operated like ordinary electrodialysis systems, except that the construction of the dilute and concentrate water spacers is different. Ordinary electrodialysis systems, as well as this invention's electrodialysis unit, are built with alternating dilute and concentrate water spacers, with alternating anion and cation ion exchange membranes between them. This stack of spacers and ion exchange membranes is then sandwiched between end pieces that house the electrolysis water and electrodes. After a direct current (DC) power supply is connected to the electrodes, the resulting electric field drives the ions contained in the dilute water within the dilute water spacers into the concentrate water contained within the concentrate water spacers, while Hydrogen and Oxygen gases are formed at the electrodes.

The dilute and concentrate water spacers in this electrodialysis system differ from ordinary dilute and concentrate water spacers in several ways. Using an x-y-z Cartesian coordinate system, the two types of water, defined here as x-water and y-water, flow through designated x-water flow spacers and y-water flow spacers in the x and y directions, respectively. The x-water flow and y-water flow spacers can contain dilute and concentrate water, respectively or concentrate and dilute water, respectively, based on the polarity of the DC power supply. The ions flow in the z direction, which is aligned with the direction of the Earth's gravitational field, meaning the x-water and y-water flow perpendicularly on a horizontal plane parallel to the plane formed by the ground of an idealized flat Earth, unlike ordinary electrodialysis units, where the two water flows are generally vertical and parallel in the central region of the spacers. Like ordinary electrodialysis units, this invention's electrodialysis unit distributes x-water to x-water flow spacers through holes in the adjacent y-water flow spacers and ion exchange membranes and distributes y-water to y-water flow spacers through holes in the adjacent x-water flow spacers and ion exchange membranes. However, in this invention's electrodialysis unit, the holes are elongated slots, providing an easy way to distribute water across the breadth of the spacers. The spacers in this invention are thicker than those in ordinary electrodialysis units, allowing for the placement of a structure around water transfer slots which carries water from an input elongated slot to the central region of spacers where ions flow and back to the output elongated slot in each spacer. This structure has enough stiffness to keep the ion exchange membranes pressed hard against the adjoining spacers and added gaskets near the water transfer slots, effectively preventing water leaks. By controlling the dimensions of the small water transfer slots in the spacer design, the leakage electric current and the associated power loss can be reduced to a desired targeted value. An example is provided demonstrating how this invention's electrodialysis unit can be used in conjunction with reverse osmosis to achieve Zero Liquid Discharge desalination operation.

### BRIEF DESCRIPTION OF THE SEVERAL VIEWS OF THE DRAWING(S)

FIG. 1: Isometric drawing showing the front face, left edge, and near edge of the x-water flow spacer, which includes arrows for the location and direction of the x-water and y-water flows

FIG. 2: Drawing showing the front view of the x-water flow spacer where the interior x-water transfer slots cannot be seen

FIG. 3: Isometric drawing showing the front face, left edge, and near edge of a sectional (cutaway) view of the x-water flow spacer where the viewing plane 3 shown in FIG. 1 is parallel to the front face and positioned halfway between the front and back faces in the z (thickness) direction

FIG. 4: Isometric drawing showing the front face, left edge, and near edge of the y-water flow spacer, which includes arrows for the location and direction of the x-water and y-water flows

FIG. 5: Isometric drawing showing the front face, left edge, and near edge of a sectional (cutaway) view of the y-water flow spacer where the viewing plane 5 shown in FIG. 4 is parallel to the front face and positioned halfway between the front and back faces in the z (thickness) direction

FIG. 6: Isometric drawing showing the front face, left edge, and near edge of a portion of the flow interrupter insert

FIG. 7: Isometric drawing showing the front face, left edge, and near edge of the anion ion exchange membranes

FIG. 8: Isometric drawing showing the front face, left edge, and near edge of the cation ion exchange membranes

FIG. 9: Isometric drawing showing the front face, left edge, and near edge of the common gaskets

FIG. 10: Isometric drawing showing the front face, left edge, and near edge of the bottom end cap which includes the inert electrode, electrode connector, input electrolyte water fitting, output electrolyte water fitting (Not shown), input x-water fitting (Not shown), and input y-water fitting (No output x-water and y-water fittings are in the bottom end cap but the similar top end cap will contain output x-water and y-water fittings, but no input x-water and y-water fittings)

FIG. 11: Isometric drawing showing the back face, left edge, and near edge of the bottom end cap obtained by rotating the bottom end cap shown in FIG. 9 one hundred eighty degrees about the y-axis and this figure includes the electrode connector (Not shown), input and output electrolyte water fittings, input x-water fitting, and input y-water fitting (No output x-water and y-water fittings are in the bottom end cap but the similar top end cap will contain output x-water and y-water fittings, but no input x-water and y-water fittings)

FIG. 12: Exploded isometric drawing of the invention's electrodialysis unit showing the front faces, left edges, and near edges of the anion and cation ion exchange membranes, x-water flow spacers, y-water flow spacers, and the bottom and top end caps, but the common gaskets present between every element of the stack are not shown

FIG. 13: Isometric drawing of the invention's assembled electrodialysis unit

FIG. 14: Isometric drawing of the invention's assembled electrodialysis unit shown being pressed together

FIG. 15: Front face view of a chunk of the invention's electrodialysis unit looking from inside the vertical column of y-water slots in the y-water flow spacers, anion and cation ion exchange membranes, common gaskets, and x-water flow spacers looking toward the large rectangularly shaped hole

FIG. 16: Block diagram showing how to obtain zero external leakage electric current in either the dilute or concentrate water external distribution systems

FIG. 17: Block diagram showing how to obtain zero external leakage electric current in the electrolysis water distribution system

FIG. 18: Approximate circuit diagram of the invention's electrodialysis unit used to determine the internal electric leakage current and the associated power loss

FIG. 19: Block diagram showing how the invention's electrodialysis unit could be used to process the wastewater from a reverse osmosis unit and have Zero Liquid Discharge ZLD operation

### DETAILED DESCRIPTION OF THE INVENTION

This invention is constructed in the same manner as ordinary electrodialysis units, which have alternating anion and cation exchange membranes separated by relatively thin alternating dilute and concentrate spacers that carry dilute and concentrate water, respectively, sandwiched between electrodes set in an electrolysis water solution. When a voltage is applied to the electrodes, an electric field is created inside the electrodialysis unit, driving the ions from the dilute water in the dilute water spacers into the concentrate water in the concentrate water spacers. However, in this invention's electrodialysis unit, the design and construction of the dilute and concentrate water spacers differ from those of ordinary electrodialysis unit spacers.

Each front and back face of the components of this electrodialysis unit, which are specifically the x-water flow and y-water flow spacers, anion and cation ion exchange membranes, common gaskets, and bottom and top end caps, subsequently discussed, lies horizontally. Assuming an ideal flat Earth, the ideal flat Earth's surface would be flat and horizontal, and an object standing vertically on this horizontal surface would be perpendicular to it. It is convenient to introduce an x-y-z Cartesian coordinate system. An object lying horizontally on the flat Earth's surface would then be parallel to the plane defined by the x and y axis of the x-y-z Cartesian coordinate system, where the z-axis points vertically upward, would be aligned with the direction of the Earth's gravitational field, and is perpendicular to the x-y horizontal plane. The sides of the components of this electrodialysis are referred to as: far and near sides are aligned with the y axis and represent the two sides relative position in the x-direction, left and right sides are aligned with x axis and represent the two sides relative position in the y-direction, and bottom and top sides (or down and up) are aligned with the x-y plane and represent the two sides relative position in the z-direction. The motion and relative pointing directions of the electrodialysis unit's components will be referred to as: through or across in the x-y plane and sometimes in the z direction, and downward or upward in the z-direction. The dimensions within each component are given as: widths in the direction of the x-axis, lengths (or long dimensions) in the direction of the y-axis, and thicknesses in the direction of the z-axis for short distances. For longer distances in the z-direction, height is used. The distance between any two arbitrary points is referred to as length. A dimensioned prototype unit is described, and these dimensions can be extrapolated to other-sized electrodialysis units. The figures shown are illustrative and not necessarily to scale, as certain features are accentuated for clarity.

Before beginning it is noted that, the x-water flow spacers and y-water flow spacers, are described with reference to the type of water and direction of its water flow. In the region within the spacers where there is ion flow, x-water flows in the direction of the x-axis and y-water flows in the direction of the y-axis in the x-water flow and y-water flow spacers respectively. Dilute or concentrate water can flow through the x-water flow spacer in the x direction and the alternate concentrate or dilute water, respectively, can flow through the y-water flow spacers in the y-direction, depending on the polarity of the DC power supply.

### X-Water Flow Spacer

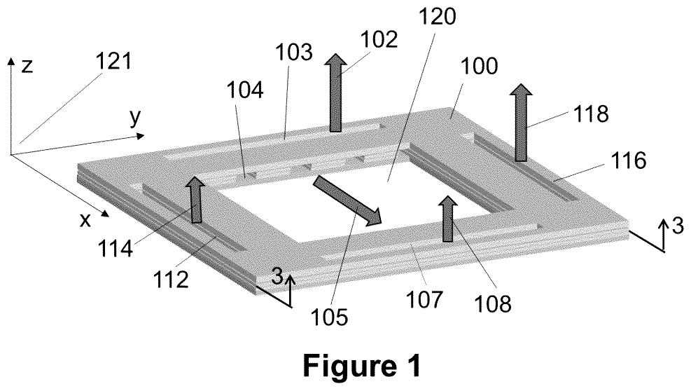

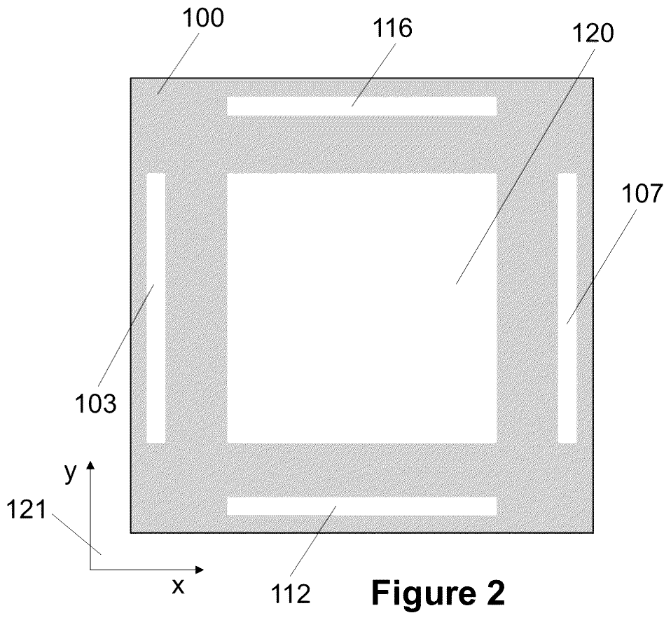

FIG. 1 shows an isometric drawing depicting the front face, left edge, and near edge of the x-water flow spacer 100, which has a square front side, which is a special case of a rectangle, and is made from a flat, rectangularly shaped non-electrically conductive material, such as plastic. Its front face lies horizontally parallel to the x-y plane. Its outer dimensions are: twenty inches in width, twenty inches in length, and three-eighths of an inch in thickness. A completely through large, rectangularly shaped hole 120, measuring twelve inches in width and twelve inches in length, is centered within the x-water flow spacer 100. A completely through input x-water slot 103 is located near the far edge, while a completely through output x-water slot 107 is near the near edge, with both slots being one inch wide and twelve inches long. Similarly, a completely through input y-water slot 112 is near the left edge, and a completely through output y-water slot 116 is near the right edge, with both slots being twelve inches wide and one inch long. The input and output x-water slots 103 and 107 are positioned one inch from the far and near edges with their long side parallel to the y-axis of the x-water flow spacer 100, respectively, and are centered along the y dimension. Likewise, the input and output y-water slots 112 and 116 are positioned one inch from the left and right edges with their long side parallel to the x-axis of the x-water flow spacer 100, respectively, and are centered along the x dimension. Digressing momentarily, the input x-water slot 103, output x-water slot 107, input y-water slot 112, output y-water slot 116, and the large rectangularly shaped hole 120 are more clearly visible in the front view of the x-water flow spacer 100, as shown in FIG. 2. FIG. 2 also displays the reference two-dimensional x-y coordinate system 121.

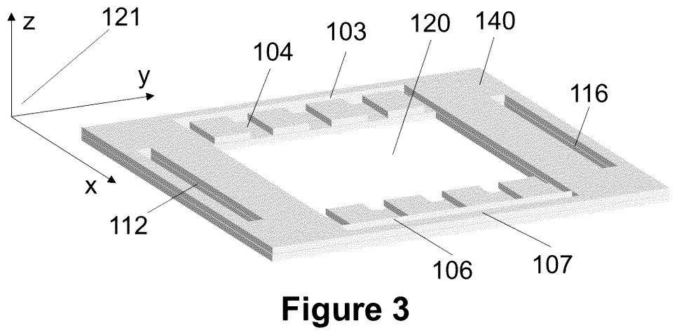

Returning to FIG. 1, besides the reference x-y-z Cartesian coordinate system 121, there is a group of interior input x-water transfer slots 104 between the input x-water slot 103 and the large rectangularly shaped hole 120. Another group of interior output x-water transfer slots exists between the large rectangularly shaped hole 120 and the output x-water slot 107, though these are not visible in this isometric drawing. In this prototype unit, each input and output x-water transfer slot are one-quarter inch in length in the y-direction, two inches in width in the x-direction, one-eighth inch in thickness in the z-direction, and centered between the front and back faces of the x-water flow spacer 100. There are about five input x-water transfer slots 104 and five output x-water transfer slots (not visible in this view). Digressing momentarily, the interior x-water transfer slots can be seen more clearly in the sectional (cutaway) view 3 of the x-water flow spacer 140, shown in the isometric drawing depicting the front face, left edge, and near edge in FIG. 3. The plane 3 of the sectional view in FIG. 3 is defined in FIG. 1 and is parallel to the front face of the x-water flow spacer, positioned halfway between its front and back faces. Referring to FIG. 3, the y-water slots 112 and 116 are located near the left and right edges, respectively, as previously defined in the discussion of FIG. 1. The x-water slots 103 and 107 are positioned near the far and near edges, respectively, as previously defined in the discussion of FIG. 1. The group of recessed input x-water transfer slots 104 is shown between the input x-water slot 103 and the large rectangularly shaped hole 120, while the group of recessed output x-water transfer slots 106 is shown between the large rectangularly shaped hole 120 and the output x-water slot 107. However, the recessed input and output x-water transfer slots 104 and 107 in FIG. 3 appear to be recessed rather than being a hole as in FIG. 1 due to the sectional view and are recessed only one-sixteenth of an inch thick due to only seeing half of the hole. FIG. 3 also includes the x-y-z Cartesian coordinate system 121.

Returning to FIG. 1, when ion exchange membranes are installed on both sides of the x-water flow spacer 100, the input x-water slot 103 receives and passes some of the x-water 102 vertically upward through the spacer while directing the rest horizontally through the group of the interior input x-water transfer slots 104 into the large rectangularly shaped hole 120. The x-water 105 then continues through the large rectangularly shaped hole 120, passes through the group of output x-water transfer slots (which are not visible), is combined with other x-water coming from below the spacer in the output x-water slot 107, and then flows 108 vertically upward out of the spacer. Additionally, the input y-water 114 passes vertically upward through the input y-water slot 112, while the output y-water 118 passes vertically upward through the output y-water slot 116. The x-water can be either dilute or concentrate water and the alternate y-water can be concentrate or dilute water, respectively.

### Y-Water Flow Spacer

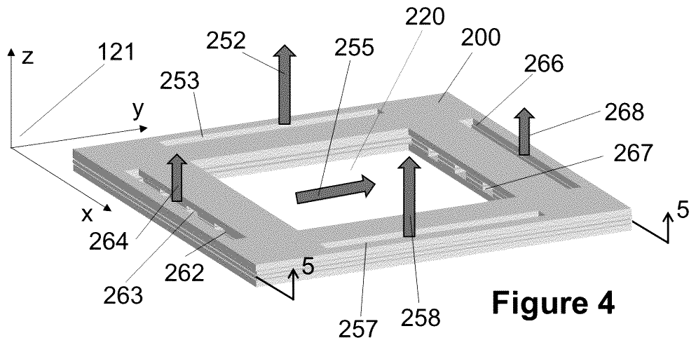

FIG. 4 shows an isometric drawing depicting the front face, left edge, and near edge of the y-water flow spacer 200, which has a square front side, which is a special case of a rectangle, and is made from a flat, rectangularly shaped non-electrically conductive material, such as plastic. Its front face lies horizontally parallel to the x-y plane. It has the same outer dimensions as the x-water flow spacer. The completely through large rectangularly shaped hole 220, input x-water slot 253, output x-water slot 257, input y-water slot 262, and output y-water slot 266 in FIG. 4 feature the same shapes, widths, lengths, and positions within the y-water flow spacer as they do in the x-water flow spacer 100 in FIG. 1. However, there is a group of interior input y-water transfer slots 263 between the input y-water slot 262 and the large rectangularly shaped hole 220, and another group of interior output y-water transfer slots 267 between the large rectangularly shaped hole 220 and the output y-water slot 266. There are no x-water transfer slots in the y-water flow spacer. The reference x-y-z Cartesian coordinate system 121 is also shown in FIG. 4.

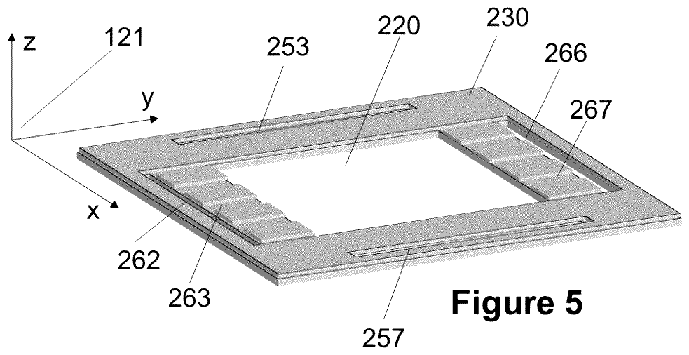

Digressing momentarily, the interior y-water transfer slots can be seen more clearly in the sectional (cutaway) view of the y-water flow spacer 230 shown in the isometric drawing depicting the front face, left edge, and near edge in FIG. 5. The plane of the sectional view 5, as defined in FIG. 4, is parallel to the front face of the y-water flow spacer and is positioned halfway between the front and back faces. Referring to FIG. 5, the y-water slots 262 and 266 are located near the left and right edges, respectively, as previously defined in the discussion of FIG. 4. The x-water slots 253 and 257 are positioned near the far and near edges, respectively, as previously defined in the discussion of FIG. 4. The group of recessed input y-water transfer slots 263 is shown between the input y-water slot 262 and the large rectangularly shaped hole 220, while the group of recessed output y-water transfer slots 267 is shown between the large rectangularly shaped hole 220 and the output y-water slot 266. In this prototype, the input and output y-water transfer slots 263, 267 are four-tenths of an inch in width in the x-direction, two inches in length in the y-direction, one-eighth inch in thickness in the z-direction, and centered between the front and back faces of the y-water flow spacer 100. There are about five input y-water transfer slots 263 and five output y-water transfer slots 267. However, the recessed input and output y-water transfer slots 263 and 267 in FIG. 5 appear to be recessed rather than being a hole due to the sectional view and are recessed only one-sixteenth of an inch thick due to only seeing half of the hole. FIG. 5 also includes the x-y-z Cartesian coordinate system 121.

Continuing with the description of FIG. 4, when ion exchange membranes are installed on both sides of the y-water flow spacer 200, the input y-water slot 262 receives and passes some of the y-water 264 vertically upward through the spacer while directing the rest of the water horizontally through the group of interior input y-water transfer slots 263 into the large rectangularly shaped hole 220. The y-water 255 then continues through the large rectangularly shaped hole 220, flows through the group of output y-water transfer slots 267, is combined with other y-water coming from below the spacer in the output y-water slot 266, and then flows 268 vertically upward out of the spacer. Additionally, the input x-water 252 passes vertically upward through the input x-water slot 253, while the output x-water 258 passes vertically upward through the output x-water slot 257. The x-water can be either dilute or concentrate water and the alternate y-water can be concentrated or dilute water, respectively.

### Flow Interrupter Inserts

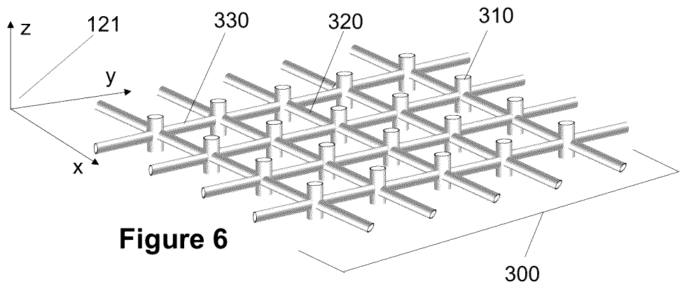

FIG. 6 shows an isometric drawing of a partial view depicting the front face, left edge, and near edge of the flow interrupter inserts 300. Their front faces lie horizontally parallel to the x-y plane. They are made from a non-electrically conducting material, such as plastic, and their overall width, length, and thickness are the same as the thickness of the x-water flow and y-water flow spacers. The flow interrupter inserts are placed into the large rectangularly shaped holes of the x-water flow and y-water flow spacers, respectively. Their purpose is to: (1) Create turbulence in the water flowing through the large rectangularly shaped hole, enhancing ion flow at the ion exchange membrane and water boundaries, and (2) Prevent the ion exchange membranes from sagging into the large rectangularly shaped hole due to expansion when wetted. There is an array of circular pegs 310 arranged in the x and y directions. These circular pegs 310 have a diameter of approximately one-eighth of an inch in an x-y plane and are the same height (thickness) as the x-water flow and y-water flow spacers. They can be spaced between one-fourth to one inch apart. The circular pegs 310 are connected by horizontal rods 320 and 330 in the x and y directions, respectively, with a diameter of approximately one-sixteenth of an inch. The horizontal rods 320 and 330 are located midway between the bottom and top of the array of circular pegs 310. Near the input and output water transfer slots, there are small mostly open spaces (Not Shown) with a size of approximately one square inch by the thickness of the inserts per water transfer slot in the flow interrupter inserts to avoid restricting the flow of water into and out of the large rectangularly shaped hole in the x-water flow and y-water flow spacers. FIG. 6 also includes the x-y-z Cartesian coordinate system (121).

### Ion Exchange Membranes and Gaskets

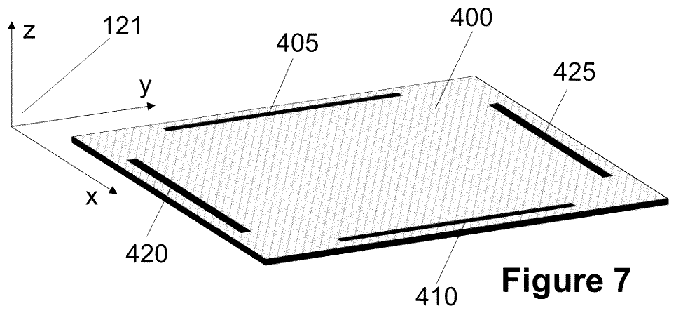

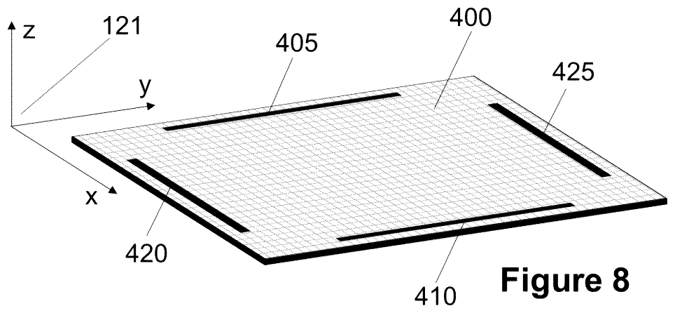

FIG. 7 and FIG. 8 show an isometric drawing depicting the front faces, left edges, and near edges of an anion or cation ion exchange membrane 400, respectively, which have the same width and length as the x-water flow and y-water flow spacers, but are only approximately 20 mils thick. Their front faces lie horizontally parallel to the x-y plane. These ion exchange membranes are solid except for the same input x-water slots 405, output x-water slots 410, input y-water slots 420, and output y-water slots 425 as the x-water flow and y-water flow spacers. Furthermore, these slots have the same shape, size, and positions within the anion and cation ion exchange membranes as they have in the x-water flow and y-water flow spacers. Therefore, when the anion and cation ion exchange membranes 400 and the x-water flow and y-water flow spacers previously discussed are stacked with their large planar surfaces adjacent to each other, individual water flows can pass through each of the input x-water slots 405, output x-water slots 410, input y-water slots 420, and output y-water slots 425 of the anion and cation ion exchange membranes 400 in FIGS. 7 and 8. FIG. 7 and FIG. 8 also include the x-y-z Cartesian coordinate system 121.

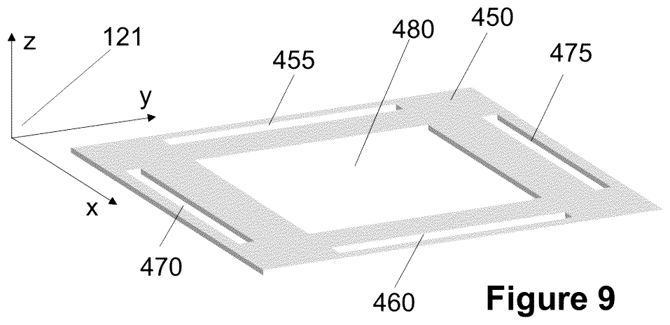

FIG. 9 shows an isometric drawing depicting the front face, left edge, and near edge of the common gaskets 450 that have the same width and length as the x-water flow and y-water flow spacers, but are approximately one-sixteenth of an inch thick. They are made from a material such as rubber or cork and their front faces lie horizontally parallel to the x-y plane. They are solid except for the same input x-water slots 455, output x-water slots 460, input y-water slots 470, output y-water slots 475, and a large rectangularly shaped holes 480 as the x-water flow and y-water flow spacers. Furthermore, these slots and the large rectangularly shaped holes have the same shape, size, and positions within the common gaskets as they have in the x-water flow and y-water flow spacers. Therefore, when the common gaskets 450, anion and cation ion exchange membranes, and the x-water flow and y-water flow spacers previously discussed are stacked with their large planar surfaces adjacent to each other, individual water flows can pass through each of the input x-water slots 455, output x-water slots 460, input y-water slots 470, and output y-water slots 475 of the common gaskets 450. Ions flow vertically through the large rectangularly shaped holes 480. FIG. 9 also includes the x-y-z Cartesian coordinate system 121.

### Bottom and Top End Caps

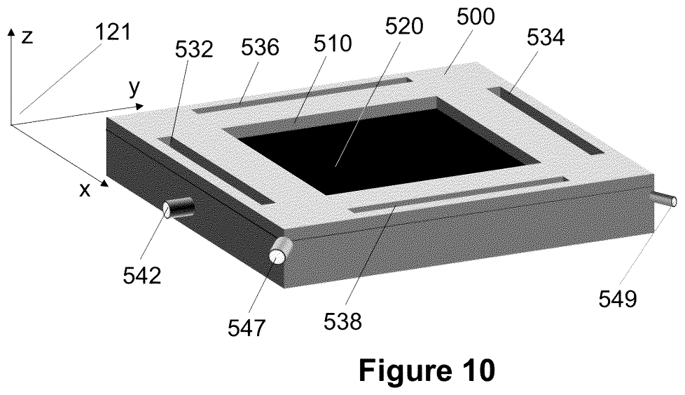

FIG. 10 shows an isometric drawing depicting the front face, left edge, and near edge of the bottom end cap 500. The top end cap, that is not shown, is identical to the bottom end cap except for the water connectors, which will be subsequently described. The bottom and top end cap's front faces lie horizontally and parallel to the x-y plane. They are made from a non-electrically conductive material, such as plastic. They have the same width and length as the x-water flow and y-water flow spacers and are approximately two inches thick. A large, rectangularly shaped recessed hole 510, with a depth of one-half inch, is centered on the front face of both the bottom and top end caps 500. The recessed hole's width and length match those of the large rectangularly shaped holes in the x-water flow and y-water flow spacers. At the bottom of the large rectangularly shaped recessed holes 510, there are one-eighth-inch thick inert electrodes 520 which fits just inside them. A graphite electrode is an example of an inert electrode. The bottom and top end caps also contain input recessed x-water slots 536, output recessed x-water slots 538, input recessed y-water slots 532, and output recessed y-water slots 534. These recessed slots have the same shapes, widths, lengths, and positions as they have in the x-water flow and y-water flow spacers except they are recessed to a depth of one and one-half inches rather than being through slots. Similar flow interrupter inserts, previously described in reference to FIG. 6, are made to precisely fit inside and on top of the inert electrodes already at the bottom of the recessed large rectangularly shaped holes, but are not shown in FIG. 10. Then these flow interrupter inserts are positioned on top of the inert electrode in the large rectangularly shaped holes. Additionally, there is an input electrolysis water fitting 547 at the near corner of both bottom and top end caps 500 and an output electrolysis water fitting at their far corner, which is not visible. Electrolysis water enters the bottom and top end cap's large rectangularly shaped recessed holes 510 through the input electrolysis water fittings 547 and exits through similar output electrolysis water fittings at the far corner that is not visible. Electrode connectors 549 are located on the right corner of the bottom and top end caps 500 and are electrically connected to the inert electrodes 520. FIG. 10 also includes the x-y-z Cartesian coordinate system 121.

Continuing with FIG. 1, for the bottom end cap, an y-input water fitting 542 is positioned on the left side, while an x-input water fitting, that cannot be seen, is located on the far side. There is a hole in the bottom end cap 500 between the y-input water fitting 542 and the input recessed y-water slot 532, as well as a hole between the x-input water fitting, that cannot be seen, and the input recessed x-water slot 538, although neither hole can be seen. There can be more than one entry hole and water fitting for the x-water and y-water into the input recessed x-water slot 536 and input recessed y-water slot 532, respectively, in the bottom end cap. There are no water fittings on the near side or the right side of the bottom end cap 500. The top end cap is not shown in a Figure, but it is identical to the bottom end cap shown in FIG. 10, except that when the recessed large rectangularly shaped hole including the flow interrupter insert, x-water slots, and y-water slots of the top end cap are facing downward in the z-direction, there is one or more y-output water fittings on the right side, one or more x-output water fittings on the near side, and no water fittings on the left and far sides of the top end cap.

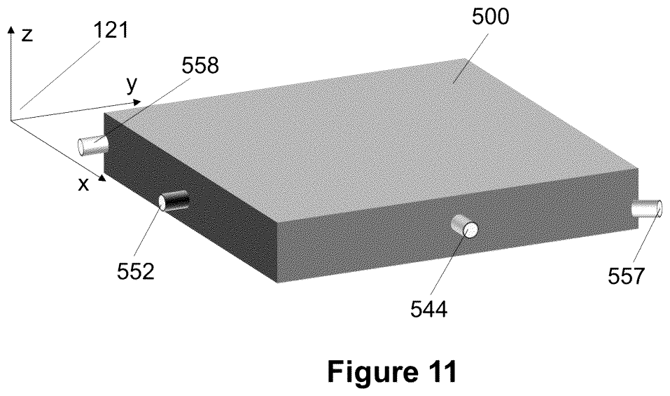

For additional information about the bottom end cap, it is viewed from its back side. The top end cap would look identical to it if it were shown, except it would have no input x-water and y-water connectors but would have output x-water and y-water connectors. An isometric drawing depicting the back face, left edge, and near edge of the bottom end cap shown in FIG. 10 is rotated 180 degrees clockwise about the y-axis so that the opposite face of the bottom end cap 500 is visible, as shown in FIG. 11. This back face of the bottom end cap 500 is simply a flat, solid surface. An y-input water fitting 552 is located on the left side of the bottom end cap 500. An x-input water fitting 544 is located on the near side of the bottom end cap 500. An output electrolysis water fitting 557 is positioned on the right corner of the bottom end cap 500, while an input electrolysis water fitting 558 is on its left corner. Electrolysis water enters the bottom end cap's large rectangularly shaped recessed hole, that is not visible, through the input electrolysis water fitting 558 passes through the recessed large rectangularly shape hole, that is not seen, and exits through the output electrolysis water fitting 557 at the right corner. There is also an electrode connector on the far corner of the bottom end cap 500, which is electrically connected to the inert electrode, but is not visible in this view. FIG. 11 also includes the x-y-z Cartesian coordinate system 121.

### Assembly of Electrodialysis Unit

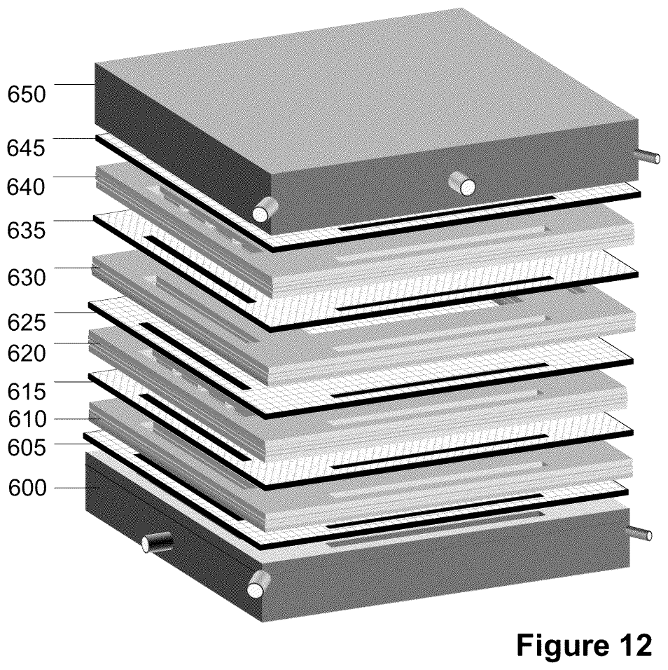

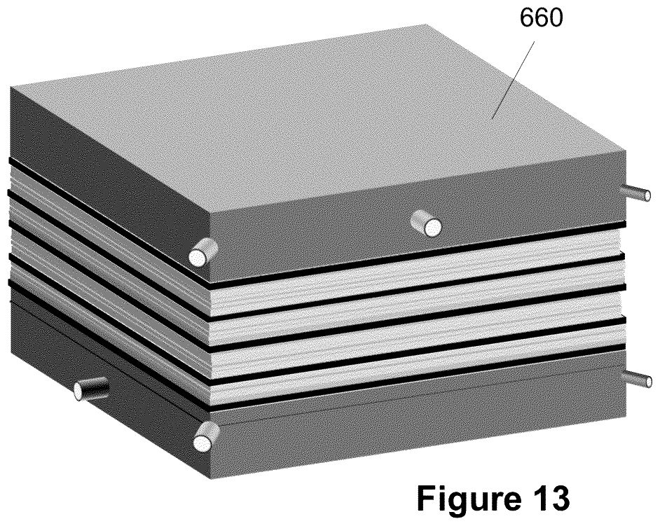

FIG. 12 shows an exploded isometric drawing depicting the front faces, left edges, and near edges of the invention's electrodialysis system. The front face of each component lies horizontally parallel to the x-y plane. The system consists of two x-water flow spacers, two y-water flow spacers, two anion ion exchange membranes, three cation ion exchange membranes, and top and bottom end caps with their recessed slots and holes facing inward. One-sixteenth-inch thick common gaskets, that are not shown, are placed between all component mating surfaces in the stack. The components are assembled in the following sequence from bottom to top: bottom end cap 600, cation ion exchange membrane 605, x-water flow spacer 610, anion ion exchange membrane 615, y-water flow spacer 620, cation ion exchange membrane 625, x-water flow spacer 630, anion ion exchange membrane 635, y-water flow spacer 640, cation ion exchange membrane 645, and top end cap 650. FIG. 13 shows an isometric drawing of the fully assembled electrodialysis unit 660, depicting the front faces, left edges, and near edges. Larger electrodialysis units would simply repeat the pattern of stacking additional layers of anion ion exchange membranes, cation ion exchange membranes, x-water flow spacers, y-water flow spacers, and common gaskets between the bottom and top end caps.

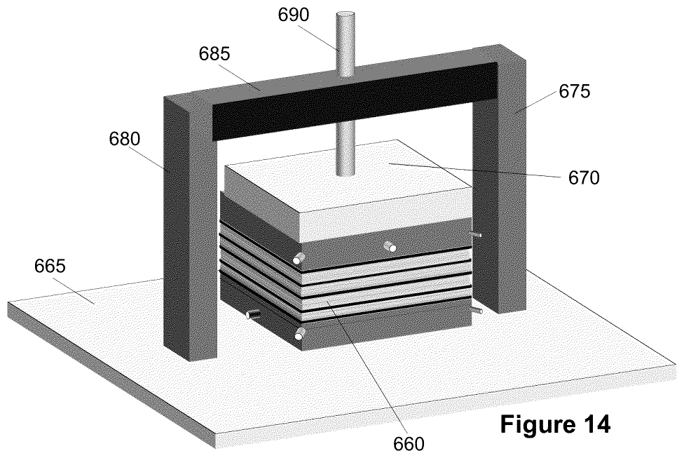

The isometric drawing in FIG. 14 illustrates one method of pressing the electrodialysis unit together to prevent water leaks. The electrodialysis unit 660 is placed inside a structure consisting of vertical members 675 and 680, a horizontal member 685, and a floor 665. A flat metal compression plate 670, having the same width and length as the electrodialysis unit 660 and a thickness of approximately one inch, is positioned on top of the electrodialysis unit 660. A screw 690 is inserted through the horizontal member 685, pressing against the compression plate 670, which in turn compresses the electrodialysis unit 660 together when the screw 690 is turned.

### No Internal and External Water Leak Properties

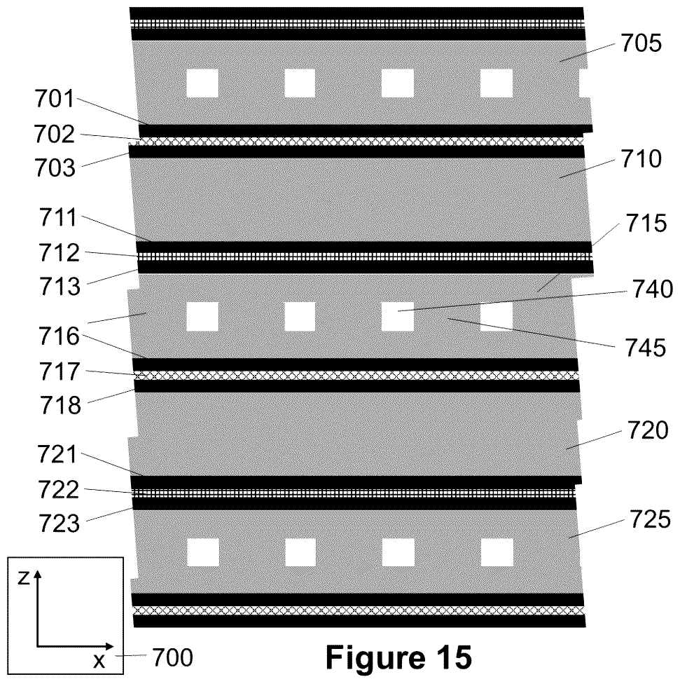

Because the region near the perimeter of the electrodialysis unit is solid from top to bottom and has gaskets between each component in the stack, there are no external water leaks once all these components are pressed together. However, there is a potential for internal water leaks between the dilute and concentrate waters because the stacked components are not completely solid in parts of the vertical regions between the x-water and y-water slots and the large rectangular shaped hole due to the internal x-water and y-water transfer slots. This issue is particularly relevant in ordinary electrodialysis systems, where the internal water transfer paths are very thin. FIG. 15 illustrates how this electrodialysis system circumvents the water leak issue. This figure provides a partial planer sectional view seen from inside the vertical column of y-water slots in the stacked set of x-water flow and y-water flow spacers looking at the face of the stack of components looking toward the large rectangularly shaped hole inside the electrodialysis unit. Before this discussion proceeds, the x and z axis 700 of the Cartesian coordinate system is given and the y axis is into the paper. Starting near the top, the stack of components includes: y-water flow spacer 705, common gasket 701, anion ion exchange membrane 702, common gasket 703, x-water flow spacer 710, common gasket 711, cation ion exchange membrane 712, common gasket 713, y-water flow spacer 715, common gasket 716, anion ion exchange membrane 717, common gasket 718, x-water flow spacer 720, common gasket 721, cation ion exchange membrane 722, common gasket 723, and y-water flow spacer 725. A group of interior y-water transfer slots 740 is present, with y-water positioned against the partial sectional view. When looking vertically from an interior y-water transfer slot 740, one can see that this vertical space is not solid throughout, and when compressed together, separation may occur between common gaskets 711 and 718, cation and anion ion exchange membranes 712 and 717, respectively, and the x-water flow spacers 710 and 720, respectively, leading to potential water leaks. If the pressure of the y-water is higher than that of the x-water, then without any structure adjacent to the y-water transfer slot, y-water from the y-water slot can leak into the x-water in the large rectangularly shaped hole near the locations of the y-water transfer slots. Conversely, if the pressure of the x-water is higher than that of the y-water, then without any structure adjacent to the y-water transfer slot, x-water from the large rectangularly shaped hole can leak into the y-water in the y-water slot near the y-water transfer slots. This is also true starting with the x-water in the x-water slots. However, in this invention, the vertical regions 745 are solid throughout the stack of components, and this rigid structure continues above and below the interior y-water transfer slots 740, ensuring that the y-water flow spacer and x-water flow spacers 715, 710, and 720, common gaskets 711, 713, 716, and 718, and anion and cation exchange membranes 712 and 717 are compressed together, preventing water leaks. In contrast, ordinary electrodialysis systems lack such a structure above and below the water transfer slots, making them more susceptible to water leaks.

### Eliminating External Leakage Electrical Current and Power Lost

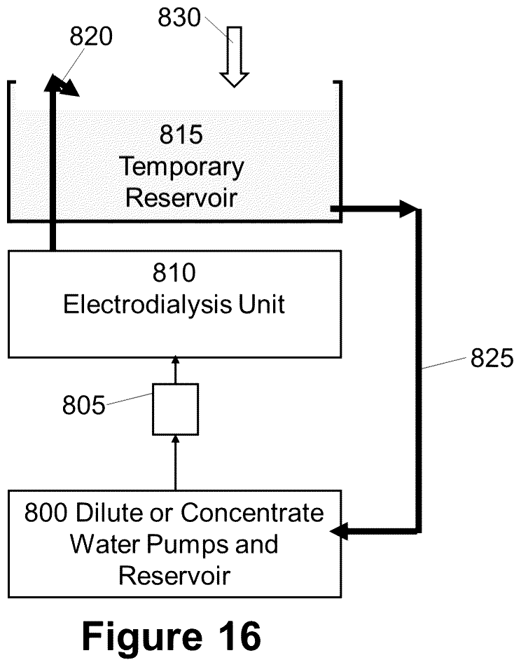

The methods used to eliminate external leakage electric current and associated power loss are described in Citation 1 of the INFORMATION DISCLOSURE STATEMENT BY APPLICANT (Form PTO/SB/08a (01-10)) under U.S. Patent Application Publications, (Pages 6 &7, FIGS. 2 & 3) and are briefly summarized here. FIG. 16 shows a block diagram of the dilute or concentrate external water distribution system. From below, either the dilute or concentrate water is pumped from a reservoir 800 through a check valve 805 into the bottom end cap of the electrodialysis unit 810. It is then sent from the top end cap of the electrodialysis unit 810 through an air gap 820 to the temporary reservoir 815, located above the electrodialysis unit 810, before draining 825 by gravity 830 back into the dilute or concentrate water reservoir 800. During normal desalination operation, which lasts approximately one hour, the pump 800 remains off, trapping either the dilute or concentrate water within the electrodialysis unit. Given that the check valve 805 has no electrical connection between one side and the other side of its gate, and an air gap 820 exists above the electrodialysis unit 810, electric current is prevented from flowing in the external dilute or concentrate water distribution systems while still allowing internal electric currents to flow within the electrodialysis unit 810. Periodically, for about one minute, the pump 800 is turned on to refresh the dilute or concentrate water in the electrodialysis unit 810. The pump 800 is then turned off again, allowing desalination to resume without external leakage current and the associated power loss in the external dilute or concentrate water distribution systems.

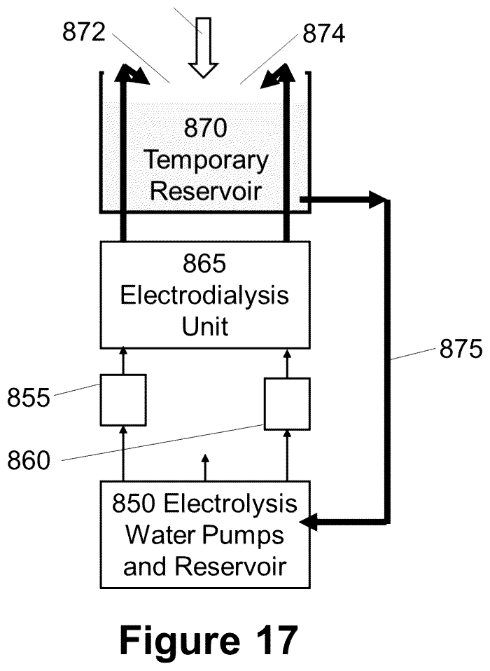

The means of preventing external leakage electric current and the associated power loss in the electrolysis water distribution system is discussed with the aid of FIG. 17. Two pumps in the electrolysis water pumps and reservoir 850 pump electrolysis water through two check valves 855 and 860 into the bottom end cap of the electrodialysis unit 865. The outputs from the top end cap of the electrodialysis unit 865 flow to a location physically above the electrodialysis unit 865, where the electrolysis water then falls through air gaps 872 and 874 into the temporary reservoir 870. The electrolysis water drains 875 out of the temporary reservoir 870 by gravity 880 back into the electrolysis water pumps and reservoir 850. During normal operation of the electrodialysis unit 850, which lasts approximately one hour, the electrolysis water pumps in the electrolysis water pumps and reservoir 850 remain off, causing the electrolysis water to stop flowing and become trapped in the electrolysis water end caps of the electrodialysis unit 850. Due to the electrically isolated check valves 855 and 860, and the lack of an electrical connection between the two air gaps 872 and 874, there is no electrical connection between the inputs and outputs of the bottom and top end caps, respectively, of the electrodialysis unit 865, preventing any leakage of external electrolysis electric current. However, gases can bubble up and escape from the bottom and top end caps of the electrodialysis unit 865. Periodically, the electrolysis pumps 850 are turned on for about one minute to remove the old electrolysis water in the electrodialysis unit 865 and replace it with fresh electrolysis water. The electrolysis pumps 850 are then turned off, allowing the electrodialysis unit 850 to return to normal operation. This process ensures that the external electrolysis electrical current remains at zero during electrodialysis operation.

An alternative to the methods discussed above for eliminating external leakage electric current and the associated power loss is to significantly increase the electric resistance in the external water distribution systems outside the electrodialysis unit and keep all the pumps operating. This ensures that only a minimal electric current flows through the external water distribution systems. This can be achieved by transporting the water through hoses with small diameters, approximately one-fourth of an inch, and lengths of tens of feet.

### Targeted Internal Leakage Electrical Current and Lost Power

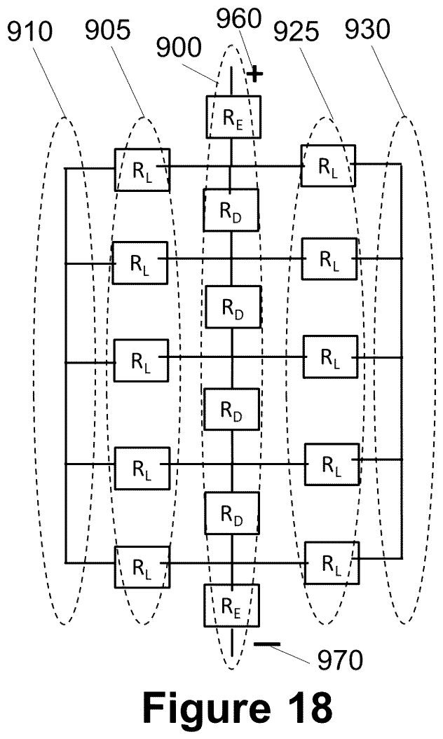

The electric current leakage through the internal concentrate water distribution system is much higher than that of the internal dilute water distribution system because the conductivity of concentrate water is significantly higher than that of dilute water. Therefore, only the leakage electric current in the internal concentrate water distribution system is discussed here, but the analysis of leakage electric current in the dilute water distribution system would be like that of the internal concentrate water distribution system. The concentrate water can be in either the x-water flow spacer or the y-water flow spacer, while the dilute water occupies the opposite spacer type. To analyze the leakage electric current, an approximate circuit diagram is constructed, as shown in FIG. 18. The electric resistance of the dilute water through the dilute water spacer is defined as R_{d} (not shown), and the electric resistance through the anion and cation ion exchange membranes is defined as R_{M} (not shown). The direct individual electric resistances R_{D} from one concentrate water spacer to the next is defined as R_{D}=R_{d}+2 R_{M}. In this example, the concentrate water is assumed to be saturated, and its electric resistance through the concentrate water spacer is approximated as zero since it is negligible compared to the electric resistance through the dilute water spacers and ion exchange membranes. The electric resistance through the bottom and top end caps, which contain electrolysis water, is defined as R_{E}. Therefore, the electrical circuit 900 that approximates the electric resistances through the entire stack of spacers and ion exchange membranes, along with the positive and negative power supply terminals 960 and 970, respectively, is shown in FIG. 18. The electric leakage resistance of the concentrate water through the input and output concentrate water transfer slots for each concentrate water spacer is defined as R_{L}. The electric resistance of the water in the input and output concentrate water slots 910 and 930 is approximated as zero. Thus, the electric resistances R_{L} correspond to the electric resistances of the water in all the input and output concentrate the water transfer slots of each spacer carrying concentrate water located between the large rectangularly shaped hole and the input and output concentrate water slots of each concentrate water spacer. The electric resistances 905 are associated with the input concentrate water transfer slots of each spacer carrying concentrate water, while the electric resistances 925 are associated with the output concentrate water transfer slots of each spacer carrying concentrate water. If the electric resistances R_{L} are much larger than the electric resistances R_{D}, then the concentrate water electric leakage current will be significantly smaller than the desired electric current flowing directly through the ion exchange membranes. Standard circuit theory can be applied to solve for the currents in the electrical circuit shown in FIG. 18, given the known electric resistances. The electric resistance R_{L} can be determined for the targeted concentrate water leakage electric currents by iteratively solving the circuit equations, and then the design parameters of the concentrate water transfer slots can be adjusted to achieve the desired electric resistance R_{L} associated with the targeted leakage electric current.

A simple example illustrates how the design can achieve the desired or targeted leakage electric current and the associated power loss. Assume the large rectangularly shaped hole is square with sides of 0.5 m (19.7 inch) giving it a cross-sectional area A of 0.25 m² (388 in²). The space d between the anion and cation ion exchange membranes housing the concentrate water is 0.01 m (0.39 inch). The area resistance R_{AR} of the ion exchange membranes is 0.003-ohm m². The resistance of an ion exchange membrane R_{M} is given by R_{M}=R_{AR}/A=0.012 ohms. Assume the salt concentration of the dilute water is 20,000 parts per million (ppm) and that of the concentrate water is 400,000 ppm. The water conductivity σ in Siemens per m is approximately given by equation σ=K times the salt concentration in ppm where K=1.3×10⁻⁴. Thus, the conductivity of the dilute water is σ_{d}=2.6 S/m and the conductivity of the concentrate water σ_{c}=52 S/m. The electric resistance through the dilute water spacer R_{d} is defined as d/(σA)=0.015 ohms. Therefore, the direct electric resistance R_{D}=R_{d}+2 R_{M}=0.039 ohms. It is beyond the scope of this discussion to iterative solve for the resistance R_{L} for a given desired leakage current. Instead, our design will simply require the electric resistance through all the input concentrate water transfer slots R_{L} of each concentrate water spacer to be one hundred times that of the direct electric resistance, then: R_{L}=3.9 ohms. The electric leakage resistance R_{L} of the concentrate water through the input and output concentrate water transfer slots R_{L} of each concentrate water spacer is given by R_{L}=L/(σ_{c}A_{C}) where A_{C} is the total cross-sectional area of the input or output concentrate water transfer slots in each concentrate water spacer and L is their length. The total cross-sectional area is given by A_{C}=N w d where: N is the number of input concentrate water transfer slots in a concentrate water flow spacer, d=0.0032 m (0.125 inches) and w=0.005 m (0.2 inches) are the thickness and width of the concentrate water transfer slot, respectively. N is the total number of the x or y water transfer slots, which is 0.5 m (length of a side of the large rectangularly shaped hole), divided by the spacing of the water transfer slots of 0.025 m (1 inch). Then N=20 and A_{C}=0.00032 m². The length L of the water transfer slot using the previous equation is solved by L=R_{L} (σ_{c} A_{C})=0.065 m (2.6 inches). This example demonstrates that the design of the electrodialysis unit can be adjusted to achieve a desired leakage electric current. First, the electric resistance through the direct path of the electrodialysis unit is computed. Then, an iterative process can be used to solve for the electric resistance R_{L} through the input and output concentrate water transfer slots of each spacer carrying concentrate water using standard circuit theory for a targeted leakage current. Once this electric resistance R_{L} is determined, the necessary design dimensions for the input and output concentrate water transfer slots can be established.

### Zero Liquid Discharge ZLD Application

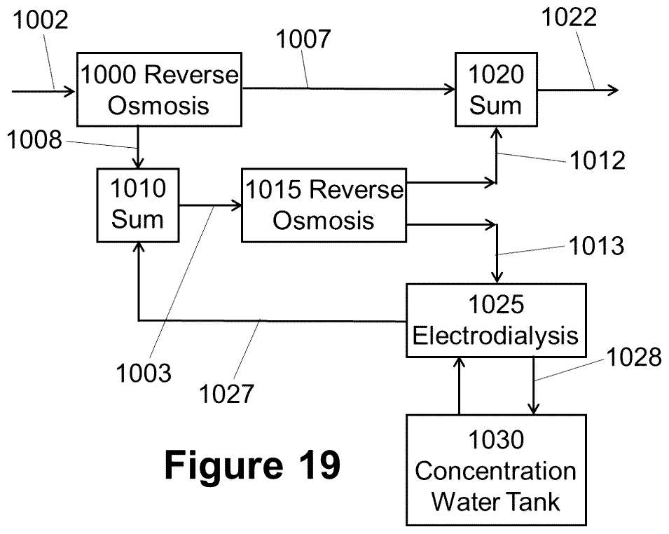

Because the electrodialysis unit in this invention has thicker dilute and concentrate water spacers than that of an ordinary electrodialysis unit so as to prevent internal cross-leaks between the dilute and concentrate water, it is best suited for operation with feed water that has relatively high conductivity. This ensures that the electric resistance through the dilute water spacer is more comparable to the electric resistance through the ion exchange membranes. One potential application is processing wastewater from a reverse osmosis desalination unit, as described in Citation 1 of the INFORMATION DISCLOSURE STATEMENT BY APPLICANT (Form PTO/SB/08a (01-10)) under U.S. Patent Application Publications (Pages 8 & 9, FIG. 43) and Citation 2 of the INFORMATION DISCLOSURE STATEMENT BY APPLICANT (Form PTO/SB/08a (01-10)) under NON-PATENT LITERATURE DOCUMENTS (Page 20 FIG. 27, Pages 27-28 FIG. 28). An idealized example of this process is described with the help of the block diagram shown in FIG. 19. One thousand gallons of saline feed water 1002, which has a salt concentration of 10,000 parts per million ppm, is fed into a reverse osmosis unit 1000. The reverse osmosis unit 1000 outputs 500 gallons of salty water 1008 with a salt concentration of 20,000 ppm into a summer 1010 and 500 gallons of water 1007 having nearly zero salt concentration to another summer 1020. The summer 1010 adds the 500 gallons of water 1008 from the reverse osmosis unit 1000 with a salt concentration of 20,000 ppm to the previously processed 500 gallons of dilute water 1027 from the electrodialysis unit 1025 which has a salt concentration of 20,000 ppm. The 1,000 gallons of salt water 1003 with a salt concentration of 20,000 ppm is passed through the reverse osmosis unit 1015. One output of the reverse osmosis unit 1015 is 500 gallons of water 1012 with nearly zero salt concentration which is added 1020 to the 500 gallons of water 1007 with nearly zero salt concentration to provide 1000 gallons of water 1022 with nearly zero salt concentration. The other 500 gallons of output water 1013 with a salt concentration of 40,000 ppm from the reverse osmosis unit 1015 is input as dilute water to the electrodialysis unit 1025 where it is reduced in salt concentration to 20,000 ppm and these 500 gallons of processed dilute water 1027 is output to the summer 1010. The concentrate water 1028, which can have a slightly supersaturated salt concentration, but remains below levels where spontaneous precipitation occurs, is circulated through a concentration water tank 1030.

If supersaturated concentrate water, while remaining below levels where spontaneous precipitation occurs, in the concentrate water tank 1030 is slowly circulated through a separate, much larger precipitation tank, solids have time to precipitate out before the water from the precipitation tank (Not Shown) is reused in the concentrate water tank 1030. With this system configuration, Zero Liquid Discharge (ZLD) operation can be achieved. Alternatively, if the electrodialysis unit intermittently circulates the concentrate water, as discussed previously in the section “Eliminating External Leakage Electrical Current and Power Loss,” there would be sufficient time for solids to precipitate out in a large concentrate water tank 1030 acting as the precipitation tank, eliminating the need for a separate precipitation tank. Returning to the desalination example of FIG. 19, the input 1,000 gallons of saline water is processed into 1,000 gallons of nearly salt free water and separated solid salt.

1. This electrodialysis unit (1) utilizes a perpendicular flow of dilute and concentrated water in the region of ion flow, (2) naturally distributes the water flow across the breadth of the dilute and concentrated water spacers, (3) prevents water leaks, and (4) provides a means to achieve a targeted amount of leakage electric current and the associated power loss in the internal dilute and concentrate water distribution systems.

2. The x-water flow and y-water flow spacers, which carry either dilute and concentrate water, respectively, or alternately concentrate and dilute water, respectively, depending on the applied polarity of the DC power supply, consist of:
A flat, rectangularly shaped non-electrically conductive material, such as plastic, with front and back faces lying horizontally parallel to a plane formed by the surface of an ideal flat Earth. An x-y-z Cartesian coordinate system is defined such that its perpendicular x and y axis lie in the plane of the ideal flat Earth's surface and the vertical z-axis is perpendicular to this plane and is aligned with Earth's gravitational field,
The sides of the x-water flow and y-water flow spacers are referred to as: far and near sides are aligned with the y axis and represent the two sides relative position in the x-direction, left and right sides are aligned with x axis and represent the two sides relative position in the y-direction, and bottom and top sides (or down and up) are aligned with the x-y plane and represent the two sides relative position in the z-direction. The motion and relative pointing directions of objects will be referred to as: through or across in the x-y plane and sometimes in the z direction, and downward or upward in the z-direction,
Their rectangularly shaped outer dimensions, as well as internal features, have widths measured in the direction of the x-axis, lengths measured in the direction y-axis, and thicknesses (or heights) measured in the direction of the z-axis of the x-y-z Cartesian coordinate system,
Both x-water flow and y-water flow spacers have identical outer dimensions ranging from ten to sixty inches in width, ten to sixty inches in length, and approximately three-eighths of an inch in thickness,
Both x-water flow and y-water flow spacers have a large, rectangularly shaped hole extending through the rectangularly shaped material at the center of their front faces, measuring on-the-order-of six inches less in width and six inches less in length of their outer dimensions,
Both the x-water flow and y-water flow spacers have an input x-water slot and an output x-water slot on their front faces extending entirely through the rectangularly shaped material,
Both the input x-water and output x-water slots are approximately one inch wide in the direction of the x-axis and have a length in the direction of the y-axis equal to the length of the far and near sides of the large rectangularly shaped hole that are aligned with the y-axis, making them appear as elongated slots,
The input x-water and output x-water slot's longest outer sides are positioned on-the-order-of one inch in the x direction from the far and near sides of the rectangularly shaped material that are aligned with the y-axis, respectively, and they are centered in the y-direction on the x-water flow and y-water flow spacers, respectively,
Both the x-water flow and y-water flow spacers have an input y-water slot and an output y-water slot on their front faces extending entirely through the rectangularly shaped material,
Both the input y-water and output y-water slots are approximately one inch in length in the direction of the y-axis and have a width in the direction of the x-axis equal to the width of the left and right sides of the large rectangularly shaped hole that are aligned with the x-axis, making them appear as elongated slots,
The input y-water and output y-water slot's longest outer sides are positioned on-the-order-of one inch in the y direction from the left and right sides of the rectangularly shaped material that are aligned with the x-axis, respectively, and they are centered in the x-direction on the x-water flow and y-water flow spacers, respectively,
In the x-water flow spacer only, an interior linear array of input x-water transfer slots is positioned between the input x-water slot and the large rectangularly shaped hole, and an interior linear array of output x-water transfer slots is positioned between the output x-water slot and the large rectangularly shaped hole,
In the x-water flow spacer only, these x-water transfer slots are on-the-order-of one-quarter inch in length in the y-direction, one-eighth of an inch thick in the z-direction, spaced about one inch apart in the y-direction, and centered in the z-direction between the front and back faces of the x-water flow spacer,
In the y-water flow spacer only, an interior linear array of input y-water transfer slots is positioned between the input y-water slot and the large rectangularly shaped hole, and an interior linear array of output y-water transfer slots is positioned between the output y-water slot and the large rectangularly shaped hole,
In the y-water flow spacer only, these y-water transfer slots are on-the-order-of one-quarter inch in width in the x-direction, one-eighth of an inch thick in the z-direction, spaced about one inch apart in the x-direction, and centered in the z-direction between the front and back faces of the y-water flow spacer,
Flow interrupter inserts, made of a non-electrically conducting material such as plastic and to fit precisely inside the large rectangularly shaped holes, are placed in the large rectangularly shaped holes in both the x-water flow and y-water flow spacers. These flow interrupter inserts create turbulence in the water flowing through the hole, enhancing ion flow at the ion exchange membrane and water boundaries and prevent the ion exchange membranes from sagging into the hole due to expansion when wetted,
One candidate for the flow interrupter inserts consist of an array of vertically standing circular pegs across a space in both the x-y directions, spaced approximately one-fourth to one inch apart, and connected by horizontally positioned rods with a diameter of approximately one-sixteenth inch. The circular pegs have a diameter of approximately one-eighth inch in the x-y plane and are the same height as the thickness of the x-water flow and y-water flow spacers in the z direction. The connecting rods are positioned midway between the top and bottom of the circular pegs,
In the x-water flow spacer, x-water flows vertically upward into the bottom of the input x-water slot, where it divides. One portion of the water continues to flow vertically upward through and out of the top of the input x-water slot, while the other portion flows horizontally through the input x-water transfer slots, through the large rectangular hole containing the flow interrupter insert, and through the output x-water transfer slots, where it combines with other x-water flowing vertically upward into the bottom of the output x-water slot. Finally, the combined water flows vertically upward out of the top of the output x-water slot,
In the y-water flow spacer, y-water flows vertically upward into the bottom of the input y-water slot, where it divides. One portion of the water continues to flow vertically upward through and out of the top of the input y-water slot, while the other portion flows horizontally through the input y-water transfer slots, through the large rectangular hole containing the flow interrupter insert, and through the output y-water transfer slots, where it combines with other y-water flowing vertically upward into the bottom of the output y-water slot. Finally, the combined water flows vertically upward out of the top of the output y-water slot,
In the x-water flow spacer only, input y-water flows vertically upward into the bottom of its input y-water slot and continues to flow vertically upward through and out of the top of its input y-water slot and output y-water flows vertically upward into the bottom of its output y-water slot and continues to flow vertically upward through and out of the top of its output y-water slot,
In the y-water flow spacer only, input x-water flows vertically upward into the bottom of its input x-water slot and continues to flow vertically upward through and out of the top of its input x-water slot and output x-water flows vertically upward into the bottom of its output x-water slot and continues to flow vertically upward through and out of the top of its output x-water slot,
In the regions of the large rectangularly shaped holes containing the flow interrupter inserts, x-water in an x-water flow spacer flows perpendicularly to y-water in a y-water flow spacer, while both flow horizontally,
The x-water and y-water flows are distributed across their large rectangularly shaped holes containing the flow interrupter inserts, respectively, via their array of x-water transfer and y-water transfer slots in their respective x-water and y-water flow spacers, and
The outside perimeter, large rectangularly shaped hole containing the flow interrupter insert, x-water and y-water slots, and x-water and y-water transfer slots can have shapes other than a rectangle if each new shape retains the same functions and capabilities as the old rectangle shapes within the x-water and y-water flow spacers.

3. The bottom and top end caps consist of:
A flat, rectangularly shaped non-electrically conductive material, such as plastic, with front and back faces lying horizontally parallel to a plane formed by the surface of an ideal flat Earth. An x-y-z Cartesian coordinate system is defined such that its perpendicular x and y axis lay in the plane of the ideal flat Earth's surface and the vertical z-axis is perpendicular to this plane and is aligned with Earth's gravitational field,
The sides of the x-water flow and y-water flow spacers are referred to as: far and near sides are aligned with the y axis and represent the two sides relative position in the x-direction, left and right sides are aligned with x axis and represent the two sides relative position in the y-direction, and bottom and top sides (or down and up) are aligned with the x-y plane and represent the two sides or objects relative position in the z-direction. The motion and relative pointing directions of objects will be referred to as: through or across in the x-y plane and sometimes in the z direction, and downward or upward in the z-direction,
Their rectangularly shaped outer dimensions, as well as internal features, have widths measured in the direction of the x-axis, lengths measured in the direction y-axis, and thicknesses (or heights) measured in the direction of the z-axis of the x-y-z Cartesian coordinate system,
The bottom and top end cap's outer width and length dimensions are the same as the x-water and y-water flow spacers described in claim , but with a thickness of approximately two inches,
The bottom and top end cap's front faces feature the same input and output x-water slots, input and output y-water slots, and large rectangularly shaped hole, with identical shapes, widths, lengths, and positions as the x-water and y-water flow spacers described in claim. However, rather than being through-holes, the x-water and y-water slots are recessed approximately one and one-half inches in the vertical z-direction, while the large rectangularly shaped hole is recessed approximately one-half of an inch in the vertical z-direction,
An approximately one-eighth-inch-thick inert electrode, such as one made from graphite, is precisely fabricated to fit at the bottom of the recessed, large, rectangularly shaped holes in both the bottom and top end caps, where they are then mounted,
Flow interrupter inserts, like the one described in Claim [2], which are precisely fabricated to fit into the recessed large rectangularly shaped holes including the inert electrodes, are placed on top of the inert electrodes which are at the bottom of the large recessed large rectangularly shaped holes of both the bottom and top end caps,
In the bottom end cap only, which has its recessed, large, rectangularly shaped hole containing the flow interrupter insert, input and output x-water slots, and input and output y-water slots facing upward in the z-direction, one or more holes are located on the far edge and the left edge, containing water fittings that allow x-water and y-water to flow into an input x-water slot and an input y-water slot from outside the bottom end cap, respectively,
In the top end cap only, which has its recessed, large, rectangularly shaped hole containing the flow interrupter insert, input and output x-water slots, and input and output y-water slots facing downward in the z-direction, one or more holes are located on the near edge and the right edge, containing water fittings that allow x-water and y-water to flow out of an output x-water slot and an output y-water slot to the outside of the top end cap, respectively
Both the bottom and top end caps have input and output electrolysis water fittings, along with associated holes in two opposite corners, leading into the recessed large rectangularly shaped hole containing the flow interrupter insert. These fittings are used to flow electrolysis water from outside the end caps, through the recessed large rectangularly shaped hole containing the flow interrupter insert, and back to outside the end caps and,
External electrode connectors are located at one of the free corners of both the bottom and top end caps, providing a connection to the inert electrodes inside them.

4. This invention's electrodialysis unit, utilizing the x-water flow spacers, y-water flow spacers, and bottom and top end caps described in Claims [2] and [3], consists of the following:
A basic subassembly, consisting of an arrangement of components vertically stacked in the z direction with their front faces lying horizontally is assembled from bottom to top as follows: cation ion exchange membrane, common gasket, x-water flow spacer, another common gasket, anion ion exchange membrane, another common gasket, and y-water flow spacer. The corresponding input and output x-water and y-water slots of these components are aligned from one layer to the next,
The cation and anion exchange membranes, each approximately 20 mils thick, lie horizontally and have the same widths and lengths as the x-water and y-water flow spacers described in Claim [2]. They also feature the same x-water slots and y-water slots, with identical shapes, widths, lengths, and positions as those of the x-water and y-water flow spacers described in Claim [2]. The slots and holes are completely through the membranes,
The common gaskets, which are approximately one-sixteenth of an inch thick and made of rubber or cork, have the same widths and lengths as the x-water and y-water flow spacers as described in Claim [2]. They feature the same x-water slots, y-water slots, and large rectangularly shaped holes, with identical shapes, widths, lengths, and positions as those of the x-water and y-water flow spacers described in Claim [2]. The slots and holes are completely through the gaskets,
The electrodialysis unit is assembled by placing the bottom face of the bottom end cap horizontally on the floor of the x-y plane with its large rectangularly shaped hole containing the flow interrupter insert, input and output x-water slots, and input and output y-water slots facing upward, followed by a common gasket. The desired number of basic subassemblies previously discussed with their faces lying horizontally and their bottom element being a cation ion exchange membrane are then stacked in the z-direction , each separated by a common gasket. Next, a common gasket followed by a cation ion exchange membrane is placed on the stack. Finally, the front face of the top end cap, with its large rectangularly shaped hole containing the flow interrupter insert, input and output x-water slots, and input and output y-water slots facing downward with an additional common gasket, is horizontally placed on top this previously listed sequential stack of components. The corresponding input and output x-water slots and input and output y-water slots of these components are aligned from one layer to the next in the stack, and the entire assembly is pressed together,
x-water enters through the bottom end cap, flows upward through all the input x-water slots in the electrodialysis unit while portions of the x-water also move horizontally through the input x-water transfer slots, large rectangularly shaped hole including the flow interrupter insert, and output x-water transfer slots of each x-water flow spacer. It then flows into the x-water slots of each x-water flow spacer where it is combined with x-water flowing upward from x-water slots of other x-water flow spacers below it and finally the x-water reaches the top end cap and exits the electrodialysis unit,
y-water enters through the bottom end cap, flows upward through all the input y-water slots in the electrodialysis unit while portions of the y-water also move horizontally through the input y-water transfer slots, large rectangularly shaped hole including the flow interrupter insert, and output y-water transfer slots of each y-water flow spacer. It then flows into the y-water slots of each y-water flow spacer where it is combined with y-water flowing upward from y-water slots of other y-water flow spacers below it and finally it reaches the top end cap and exits the electrodialysis unit,
The x-water in the x-water flow spacers flows perpendicularly to the y-water in the y-water flow spacers in the large rectangularly shaped regions containing the flow interrupter inserts and the x-water and y-water transfer slots, while both waters flow horizontally,
Electrolysis water is fed into the input electrolysis water connectors and out of the output electrolysis water connectors of both the bottom and top end caps,
When a DC power supply is connected to the bottom and top electrode connectors, ions flow vertically within the region of the large rectangularly shaped holes containing the flow interrupter inserts in the electrodialysis unit,
When the inert electrode in the bottom end cap is charged negatively and the inert electrode in the top end cap is charged positively, the x-water flow spacers carry dilute water, while the y-water flow spacers carry concentrate water, and
When the inert electrode in the bottom end cap is charged positively and the inert electrode in the top end cap is charged negatively, the x-water flow spacers carry concentrate water, while the y-water flow spacers carry dilute water.

5. Because a stiff, rigid material structure is positioned above and below the x-water and y-water transfer slots and is consistently maintained across the entire breadth of the x-water and y-water flow spacers, as described in Claim [2], no water leaks, either internally or externally, can occur when the x-water and y-water flow spacers, anion and cation ion exchange membranes, common gaskets, and bottom and top end caps are pressed together as described in Claim [4].

6. By adjusting the dimensions of the x-water or y-water transfer slots in the x-water or y-water flow spacers, as described in Claim [2], their electric resistances, determined by their size and the conductivity of the water, can be controlled to ensure that the internal leakage electric current and the associated power loss remain below a targeted value.
